(19) United States
(12) Patent Application Publication
(10) Pub. No.: US 2017/0308574 A1
(43) Pub. Date: Oct. 26, 2017

(54) METHOD AND APPARATUS FOR REDUCING QUERY PROCESSING TIME BY DYNAMICALLY CHANGING ALGORITHMS AND COMPUTER READABLE MEDIUM THEREFOR

(71) Applicant: TmaxData Co., Ltd., Gyeonggi-do (KR)

(72) Inventor: Donghyun Kim, Seoul (KR)

(73) Assignee: TmaxData Co., Ltd

(21) Appl. No.: 15/167,021

(22) Filed: May 27, 2016

(30) Foreign Application Priority Data
Apr. 25, 2016 (KR) 10-2016-0049903

(51) Int. Cl. G06F 17/30

(52) U.S. Cl. CPC G06F 17/30463; G06F 17/3046

(57) ABSTRACT

Provided is a method for reducing a query processing time by dynamically changing algorithms in a database management system (DBMS). The method includes: receiving a database query from a client; executing a first performance test for a plurality of respective execution algorithms for performing an operation associated with the query; executing an operation for processing the query by using a first execution algorithm among the plurality of execution algorithms based on a result of the first performance test; and while initially executing the operation for processing the query by using the first execution algorithm, executing a second performance test for the plurality of respective execution algorithms for performing the operation associated with the query; and dynamically deciding a point of time when the first execution algorithm is changed to a second execution algorithm among the plurality of execution algorithms in processing the query based on a result of the second performance test.

### CROSS-REFERENCE TO RELATED APPLICATIONS

This application claims priority to and the benefit of Korean Patent Application No. 10-2016-0049903 filed in the Korean Intellectual Property Office on 25 Apr. 2016, the entire contents of which are incorporated herein by reference.

### TECHNICAL FIELD

The present disclosure relates to a database management system (DBMS), and more particularly, to a technology for reducing a query processing time in a DBMS.

### BACKGROUND ART

The business of some enterprises has rapidly expanded with an explosive increase of data and appearance of various environments and platforms. With the advent of a new business environment, more efficient and flexible processing of a data service and information and a data management function are required. According to such changes, research into a database for solving problems in high performance, high availability and extensibility, which are a basis of enterprise business implementation, continues.

In a database management system (DBMS), data can be stored in a data storage. In a relational database management system (RDBMS), the data storage may be designated as a table. The table can include one or more rows and each of the one or more rows can include one or more columns.

When the database includes a large quantity of data, a relatively long time can be required for performing a query for retrieving data in which a user has an interest. When a lot of time is required for the database to respond to the query, a bad influence can be exerted on performance of the database.

A plurality of execution algorithms can be considered in association with a scheme that processes a query issued from a client. Since the respective execution algorithms have different attributes, it is necessary to determine an algorithm most suitable for processing the corresponding query before processing the corresponding query.

U.S. Pat. No. 5,598,559 presents contents regarding optimization of the query for the relational database. In the aforementioned US registered patent, since a cost based optimizer statically estimates the performances of the execution algorithms before performing a query calculation and thereafter, performs only one algorithm generated as a result of the calculation, a situation in which prediction is not appropriate may be present or variables generated during a run-time process may not be considered.

Accordingly, there is a demand in the relevant business field for a technique for reducing the query processing speed by more efficiently selecting the execution algorithms for processing the query.

### SUMMARY OF THE INVENTION

The present disclosure has been made in an effort to reduce a query processing time in a DBMS in order to satisfy the demand in the aforementioned relevant business field.

An exemplary embodiment of the present disclosure provides a method for reducing a query processing time by dynamically changing algorithms in a database management system (DBMS). The method may include receiving a database query from a client; executing a first performance test for a plurality of respective execution algorithms for performing an operation associated with the query; executing an operation for processing the query by using a first execution algorithm among the plurality of execution algorithms based on a result of the first performance test; and while executing the operation for processing the query by using the first execution algorithm, executing a second performance test for the plurality of respective execution algorithms for performing the operation associated with the query; and dynamically determining a point of time when the first execution algorithm is changed to a second execution algorithm among the plurality of execution algorithms in processing the query based on a result of the second performance test.

Another exemplary embodiment of the present disclosure provides a computer program which is stored in a computer-readable medium including encoded commands. The computer program allows one or more processors to perform following operations for reducing a query processing time by dynamically changing algorithms in a DBMS when the computer program is executed by one or more processors of a computer system and the operations include: an operation of receiving a database query from a client; an operation of executing a first performance test for a plurality of respective execution algorithms for performing an operation associated with the query; an operation of executing an operation for processing the query by using a first execution algorithm among the plurality of execution algorithms based on a result of the first performance test; and while executing the operation for processing the query by using the first execution algorithm, an operation of executing a second performance test for the plurality of respective execution algorithms for performing the operation associated with the query; and an operation of dynamically determining a point of time when the first execution algorithm is changed to a second execution algorithm among the plurality of execution algorithms in processing the query based on a result of the second performance test.

Yet another exemplary embodiment of the present disclosure provides a database management device for reducing a query processing time by dynamically changing algorithms. The device may include a query receiving module configured to receive a database query from a client; a performance test executing module configured to execute a first performance test for the plurality of respective execution algorithms for performing the operation associated with the query; and a query processing module configured to execute an operation for processing the query by using a first execution algorithm among the plurality of execution algorithms based on a result of the first performance test, wherein while the performance test executing module performs the operation for processing the query by using the first execution algorithm, the performance test executing module is additionally configured to execute a second performance test for the plurality of respective execution algorithms for performing the operation associated with the query, and wherein the database management device further includes an algorithm changing module for dynamically determining a point of time when the first execution algorithm is changed to a second execution algorithm among the plurality of execution algorithms in processing the query based on a result of the second performance test.

According to exemplary embodiments of the present disclosure, a query processing time can be reduced in a DBMS.

### BRIEF DESCRIPTION OF THE DRAWINGS

Various aspects are now described with reference to the drawings and like reference numerals are generally used to designate like elements. In the following exemplary embodiments, for description, multiple specific detailed matters are presented to provide general understanding of one or more aspects. However, it will be apparent that the aspect(s) can be executed without the specific detailed matters. In other examples, known structures and apparatuses are illustrated in a block diagram form in order to facilitate description of one or more aspects.

FIG. 1 illustrates a schematic view of a database management device and a client according to an exemplary embodiment of the present disclosure.

FIG. 2 illustrates a block diagram of a DBMS according to an exemplary embodiment of the present disclosure.

FIG. 3 is a flowchart of a method for reducing a query processing time by dynamically changing an algorithm executed in a DBMS according to an exemplary embodiment of the present disclosure.

FIG. 4 is a flowchart of a method for reducing a query processing time by dynamically changing an algorithm executed in a DBMS according to an exemplary embodiment of the present disclosure.

FIG. 5 is a diagram illustrating a comparison of the query processing time of the present disclosure and a query processing time in other related art.

FIG. 6 illustrates a simple and general schematic view of an exemplary computing environment in which exemplary embodiments of the present disclosure can be implemented.

### DETAILED DESCRIPTION

Various embodiments and/or aspects are now disclosed with reference to drawings. In the following description, for description, multiple detailed matters are disclosed in order to help overall understanding of one or more aspects. However, those skilled in the art will be able to recognize that the aspect(s) can be executed without the detailed matters. In the following disclosure and the accompanying drawings, specific exemplary aspects of one or more aspects will be described in detail. However, the aspects are exemplary and some among various methods f various aspects may be used and the descriptions are intended to include all of the aspects and equivalents thereof.

Various aspects and features will be presented by a system which can include multiple devices, components, and/or modules. It should also be appreciated and recognized that various systems can include additional devices, components, and/or modules and/or that the various systems cannot include all of devices, components, modules, and the like discussed in association with the drawings.

It may not be construed that “embodiment”, “example”, “aspect”, “illustration”, and the like used in the specification, a described predetermined aspect or design is more excellent or advantageous than other aspects or designs. ‘Component’, ‘module’, ‘system’, ‘interface’, and the like which are terms used below can generally mean computer-related entities and mean, for example, hardware, a combination of hardware and software, and software.

The term “or” is intended to mean not exclusive “or” but inclusive “or”. That is, when not separately specified or not clear in terms of a context, the case where “X uses A or B” is intended to mean one of natural inclusive substitutions. That is, the case where “X uses A or B” may be applied to either of the case where X uses A, the case where X uses B, or the case where X uses both A and B. Further, it should be understood that the term “and/or” used in the specification designates and include all available combinations of one or more items among the enumerated related items.

The word “comprises” and/or “comprising” means that the corresponding feature and/or component is present, but it should be appreciated that presence or inclusion of one or more other features, components, and/or a group thereof is not excluded. Further, when not separately specified or not clear in terms of the context by indicating a singular form, it should be construed that the singular form generally means “one or more” in the present specification and claims.

Computer readable media in the present specification may include all kinds of storage media storing programs and data to be readable by the computer system. According to an aspect of the present disclosure, the media may include a read only memory (ROM), a random access memory (RAM), a compact disk (CD)-ROM, a digital video disk (DVD)-ROM, a magnetic tape, a floppy disk, an optical data storage device, and the like and also include media implemented in the form of a carrier wave (for example, transmission through the Internet). Additionally, the media are distributed to systems connected through a network to store computer readable codes and/or commands in a distribution scheme.

Prior to describing detailed contents for carrying out the present disclosure, it should be noted that configurations not directly associated with the technical gist of the present disclosure are omitted within the scope without departing from the technical gist of the present disclosure. Further, terms or words used in the present specification and claims should be interpreted as meanings and concepts which match the technical spirit of the present disclosure based on a principle to define appropriate concepts of the terms in order for an inventor to describe his/her invention by a best method.

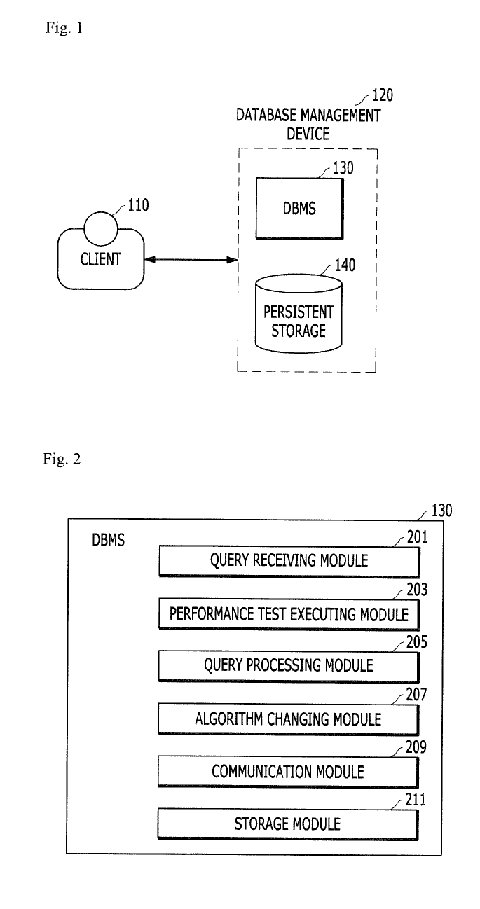

FIG. 1 illustrates a schematic view of a database management device 120 and a client 110 according to an exemplary embodiment of the present disclosure.

As illustrated in FIG. 1, a database system may include a client 110 and a database management device 120. The database management device in the present specification may be used to be interchanged with a database server.

As illustrated in FIG. 1, the client 110 may mean a node(s) in the database system having a mechanism for communication through a network. For example, the client 110 may include a PC, a laptop computer, a workstation, a terminal, and/or a predetermined electronic device having network accessibility. Further, the client 110 may include a predeteiinined server implemented by at least one of an agent, an application programming interface (API), and a plug-in. For example, the client 110 in FIG. 1 may be related with a user who uses the database management device 120. In this example, the client 110 may issue a query to the database management device 120.

The database management device 120 may include, for example, a predetermined type of computer system or computer device such as a microprocessor, a main frame computer, a digital single processor, a portable device, and a device controller. The database management device 120 may include a database management system (DBMS) 130 and a persistent storage 140. In FIG. 1, one database management device is illustrated, but it will be apparent to those skilled in the art that more than one database server (management device) may also be included in the scope of the present disclosure.

Although not illustrated in FIG. 1, the database management device 120 may include one or more memories including a buffer cache. Further, although not illustrated in FIG. 1, the database management device 120 may include one or more processors. Accordingly, the DBMS 130 may be operated by the processor on the memory.

Herein, the memory as a primary storage device which a processor autonomously accesses may mean a volatile storage device in which when a power supply is turned off, stored information is instantaneously erased, such as random access memories (RAM) such as a dynamic random access memory (DRAM), a static random access memory (SRAM), and the like, but is not limited thereto. The memory may be operated by the processor. The memory may temporarily store a data table including a data value. The data table may include the data value and in an exemplary embodiment of the present disclosure, the data value of the data table may be recorded in the persistent storage from the memory. In an additional aspect, the memory may include the buffer cache and data may be stored in a data block of the buffer cache. The data may be recorded in the persistent storage by a background processor.

The persistent storage 140 means, for example, a non-volatile storage medium which may continuously store predetermined data such as a storage device based on the flash memory and/or the battery-backup memory as well as a magnetic disk, the optical disk, and the magneto-optical storage device. The persistent storage 140 may communicate with processors and memories of the database management device 120 through various communication means. In an additional exemplary embodiment, the persistent storage 140 is positioned outside the database management device 120 to communicate with the database management device 120.

The DBMS 130 as a program for permitting the database management device 120 to perform operations such as searching, inserting, modifying, and/or deleting required data may be implemented by the processor in the memory of the database management device 120 as described above.

The client 110 and the database management device 120 or the database management devices may communicate with each other through a network (not illustrated). A network according to an exemplary embodiment of the present disclosure may use various wired communication systems such as public switched telephone network (PSTN), x digital subscriber line (xDSL), rate adaptive DSL (RADSL), multi rate DSL (MDSL), very high speed DSL (VDSL), universal asymmetric DSL (UADSL), high bit rate DSL (HDSL), and local area network (LAN).

The network presented in the present specification may use various wireless communication systems such as such as code division multiple access (CDMA), time division multiple access (TDMA), frequency division multiple access (FDMA), orthogonal frequency division multiple access (OFDMA), single carrier-FDMA (SC-FDMA), and other systems. Additionally, the network may include a database link (dblink), and as a result, a plurality of database management devices communicates with each other through the database link to bring data from another database management device. The technologies described in the present specification may be used in other networks as well as the mentioned networks.

FIG. 2 illustrates a block diagram of a DBMS 130 according to an exemplary embodiment of the present disclosure.

As illustrated in FIG. 2, the DBMS 130 may include a query receiving module 201, a performance test executing module 203, a query processing module 205, an algorithm changing module 207, a communication module 209, and a storage module 211. The components illustrated in FIG. 2 are exemplary and some components may be omitted or additional components may be added according to an implementation aspect of the present disclosure.

The query receiving module 201, the performance test executing module 203, the query processing module 205, and the algorithm changing module 207 may be included in an optimizer of the DBMS 130. As another example, the query processing module 205 may be included in an executer of the DBMS 130 and the query receiving module 201 may be included in a parser or a transformer of the DBMS 130.

The query receiving module 201 may receive the query issued from the client 110. The query receiving module 201 may perform a specific operation for the received query. For example, the query is parsed, transformed, and optimized and thereafter, executed according to an optimized query statement in the DBMS 130. Additionally, when the query receiving module 201 receives the corresponding query, the query receiving module may automatically determine a plurality of (candidate) execution algorithms therefor or determine a plurality of (candidate) execution algorithms therefor based on a hint received from the client.

In an aspect of the present disclosure, the query may include a query associated with a sort/group by operator. In this case, the plurality of algorithms may include a quick-sort based group by algorithm and an R-B tree based group by algorithm.

The performance test executing module 203 may perform a first performance test for a plurality of respective execution algorithms for executing an operation associated with the query. In the first performance test, some data (for example, data of 10% of all data or data which may be processed by using approximately 10% of an available memory) associated with the query are processed in parallel or according to a predetermined order by using the plurality of respective determined execution algorithms to extract a first value of each of one or more performance variables for the respective determined execution algorithms. The performance variable of the first value may be subsequently used to determine a predicted performance value. When the predicted performance values for the respective execution algorithms are determined, an execution plan of one of the respective execution algorithms may be selected for optimization of query execution.

The performance test executing module 203 may perform a second performance test for the plurality of respective execution algorithms for executing the operation associated with the query while executing the operation for processing the query according to a specific execution algorithm. The second performance test may include deciding a second predicted performance value for each of the plurality of execution algorithms based on a second value of each of one or more performance variables dynamically acquired while executing the operation (that is, the algorithm determined according to the first performance test) for processing the query. The present disclosure may permit a first execution algorithm to be dynamically changed to a second execution algorithm during a runtime of processing the corresponding query according to the second predicted performance value.

That is, the present disclosure relates to a technique that extracts the performance variables of the corresponding execution algorithms with a small quantity of data in an initial stage and thereafter, dynamically calculates predicted performance of the corresponding algorithms by using the performance variables and executes the query operation while changing the execution algorithm according to the predicted performance at the time of executing the query operation in which the plurality of execution algorithms is present. Accordingly, since actual data is processed in an initial stage of executing the query operation and the performance variables of the execution algorithms are extracted and the algorithm is dynamically changed based on the predicted performance, the query may be more efficiently processed than a scheme executed in the existing cost based optimizer that decides one execution algorithm among the plurality of execution algorithms before processing the query and thereafter, processes the corresponding query according to the decided execution algorithm.

In other words, in the existing query operation executing scheme, it is disadvantageous in that since a cost based optimizer statically estimates the performances of the execution algorithms and thereafter, performs only one algorithm generated as a result of the calculation, the situation in which the prediction is not appropriate may be present or variables generated during a run-time process may not be considered. However, in the case of a technical feature according to the present disclosure, dynamic optimization may be flexibly implemented with respect to various query operation execution environments.

The query processing module 205 may execute the operation for the corresponding query. The query processing module 205 initially processes some data associated with the received query by using the plurality of respective execution algorithms to permit a first performance test executing module to extract the performance variables (values). Further, the query processing module 205 may execute the operation for processing the query according to a first execution algorithm decided after executing the first performance test. Moreover, when the query processing module 205 senses a change point of time to another execution algorithm (for example, the second execution algorithm) while processing the query according to the first execution algorithm, the query processing module 205 may change the first execution algorithm to another execution algorithm (for example, the second execution algorithm) and thereafter, execute the operation for processing the query.

The algorithm changing module 207 may dynamically decide the change point of time from the first execution algorithm to the second execution algorithm. Further, the algorithm changing module 207 may automatically execute the change between the algorithms used to process the corresponding query. The algorithm changing module 207 may dynamically decide to change the current algorithm to an algorithm having a most excellent performance value among the plurality of algorithms based on a result value (that is, the second predicted performance value) for the second performance test.

The communication module 209 may provide a communication function with another database management device or the client 110. For example, the communication module 209 may transmit a processing result of the received query to the client 110. Further, the communication module 209 may communicate with another database management device or the client 110 by using the aforementioned predetermined network and/or database link. In addition, the communication module 209 may receive data storage, inquiry and index build, an inquiry request, and the like from the client 110. Besides, the communication module 209 may transfer result information for the data storage, the inquiry and index build, and the inquiry request.

The storage module 211 may store predetermined data stored in association with task execution of the database management device 120. The storage module 211 may be included in the DBMS 130 and/or the persistent storage 140. Additionally, the storage module 211 may generate a table on the database management device 120, and the like. For example, the tables may be generated by a separate component such as a control module (not illustrated). Further, the storage module 211 may process and manage a request associated with storage (including update) of data. The storage module 211 may decide to store the data and an index table. Further, the storage module 211 may decide a storage position for the data and/or the index table. For example, the storage module 207 may decide a storage position of data on the data table. As another example, the storage module 211 may decide a storage position of data on the persistent storage 140.

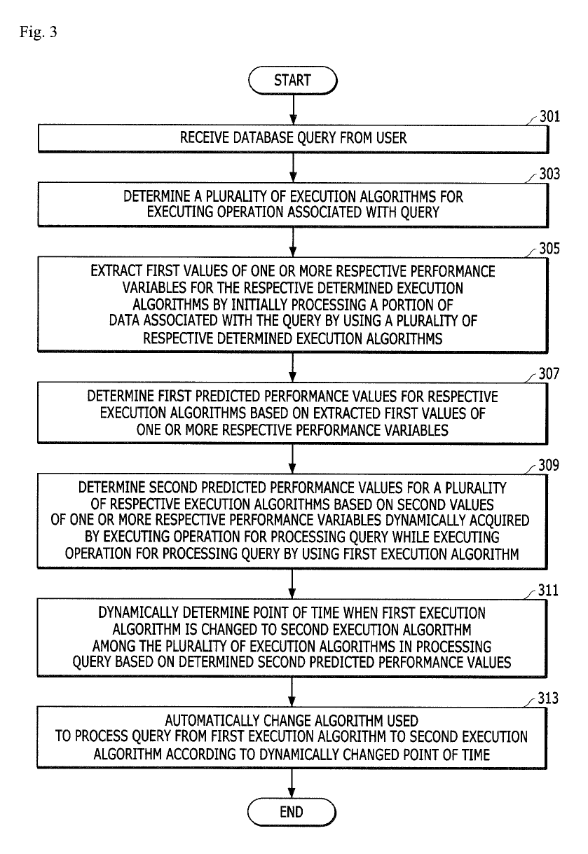

FIG. 3 is a flowchart of a method for reducing a query processing time by dynamically changing an algorithm executed in a DBMS according to an exemplary embodiment of the present disclosure. Steps illustrated in FIG. 3 may be performed by the database management device 120 (for example, the DBMS 130). Additionally, the steps illustrated in FIG. 3 may be performed by the components in the DBMS 130 illustrated in FIG. 2. As another example, the steps illustrated in FIG. 3 may be performed by the optimizer and/or an executor in the DBMS.

As illustrated in FIG. 3, the database management device 120 (for example, the query receiving module 201) may receive the database query from the client 110 (301).

Then, the database management device 120 may decide a plurality of execution algorithms for executing the operation associated with the received query (303).

The plurality of execution algorithms may be predecided according to an operator included in the corresponding query. The decision may be performed by, for example, the query receiving module 201. For example, a prediction performance value Tₐ of the first execution algorithm may be expressed as a performance function Tₐ=fₐ(xₐ₁, xₐ₂, xₐ₃, xₐ₄, . . . , xₐₙ) and a predicted performance value T_{b} of the second execution algorithm may be expressed as a performance function T_{b}=f_{b}(x_{b1}, x_{b2}, x_{b3}, x_{b4}, . . . , x_{bn}). Herein, Tₐ and T_{b} as predicted performance values of algorithms have values associated with “time”. Further, xₐₙ and x_{bn} may mean “performance variables” that influence the performance of the execution algorithm.

A case in which the database query issued from the client 110 is “Select sum (A), B from T group by B” and a case in which a table T including columns A and B is as shown below are described as an example.

TABLE 1

| A | B |
|---|---|
| 1 | 1 |
| 2 | 2 |
| 3 | 1 |
| 4 | 2 |

(Table T)

A result depending on the aforementioned database query is described below.

TABLE 2

| Sum (A) | B |
|---|---|
| 4 | 1 |
| 6 | 2 |

(Result of Database Query)

As expressed in Table 2, in the aforementioned database query, values of column B may be grouped by the unit of the group by a group by operator and column A may be aggregated to correspond to column B.

An algorithm for processing operators associated with Sort (Group By) may include, for example, a Quick-Sort Based Group By algorithm and an R-B Tree Based Group By algorithm. Herein, the quick-sort based group by algorithm is described as an example of the first execution algorithm and the R-B Tree Based Group By algorithm is described as an example of the second execution algorithm. The performance prediction value Tₐ for the quick-sort Based Group By algorithm may be decided according to a performance variable called “the number of rows (Tₐ=fₐ(row cnt)) and the performance prediction value T_{b} for the R-B Tree Based Group By algorithm may be decided according to a performance variable called “the number of groups”.

Referring back to FIG. 3, the database management device 120 (for example, the performance test executing module 203 and/or the query processing module 205) initially processes some data associated with the query by using the plurality of respective decided execution algorithms to extract first values of one or more respective performance variables for the respective decided execution algorithms (305).

In the aforementioned example, the database management device 120 applies the first execution algorithm and the second execution algorithm which are predecided in order to process the corresponding query to a small quantity of data to extract the first values of the performance variables for each algorithm. That is, the number of rows and/or the number of groups of tables associated with some data may be extracted.

Then, the database management device 120 (for example, the performance test executing module 203) may decide first predicted performance values for the respective execution algorithms based on the extracted first values of the one or more respective performance variables (307).

That is, Tₓ value is decided for each of the respective algorithms based on the first values of the performance variables to select an algorithm having a smallest value of Tₓ (that is, having the most excellent performance). In this example, it is assumed that the first execution algorithm is selected.

Then, the database management device 120 (for example, the query processing module 205) performs the operation for the corresponding query by using the selected first execution algorithm. The database management device 120 (for example, the performance test executing module 203 and/or the query processing module 205) may decide second predicted performance values for the plurality of respective execution algorithms based on second values of one or more respective performance variables dynamically acquired while executing the operation for processing the corresponding query during executing the operation for processing the query by using the first execution algorithm (309).

That is, the database management device 120 may dynamically decide T′ₓ values for the respective execution algorithms by a predecided period unit or at the predecided number of times or in real time during executing the operation for the corresponding query by using the first execution algorithm. The T′ₓ values for the respective execution algorithms which are dynamically decided may be different from the Tₓ value decided in step 307 as the values of the performance variables are different from each other. The reason is that while executing the operation for the corresponding query, the number rows and the number of groups accumulated, and processing capabilities of the memory or CPU at a specific point of time may be actually different.

Therefore, the database management device 120 (for example, the algorithm changing module 207) may dynamically decide the point of time when the first execution algorithm is changed to the second execution algorithm among the plurality of execution algorithms in processing the query based on the decided second predicted performance values.

That is, the database management device 120 compares the T′ₓ value for the respective execution algorithms again to decide the execution algorithm having the most excellent performance (that is, the smallest value of T′ₓ). Further, the database management device 120 may dynamically decide a point of time when the second predicted performance value of the first execution algorithm is not more excellent than the second predicted performance value of the second execution algorithm. Accordingly, at a point of time when the second predicted performance value of the second execution algorithm is more excellent than the second predicted performance value of the first execution algorithm, the database management device 120 may automatically change the algorithm used for processing the query from the first execution algorithm to the second execution algorithm (313).

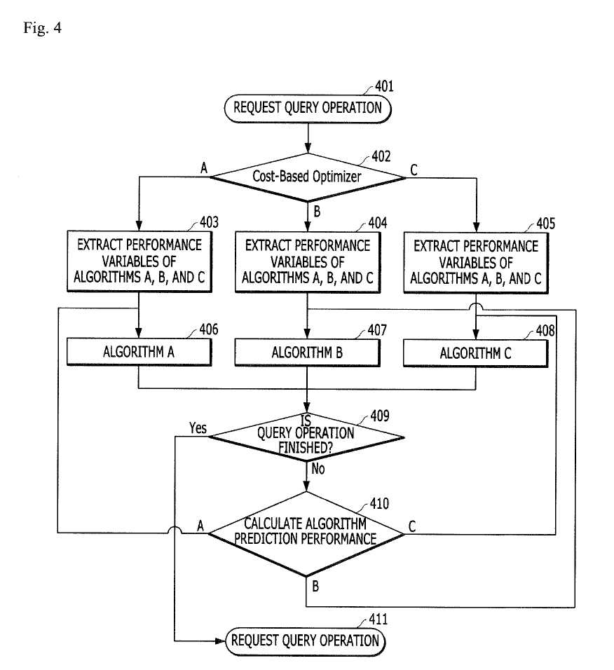

FIG. 4 is a flowchart of a method for reducing a query processing time by dynamically changing an algorithm executed in a DBMS according to an exemplary embodiment of the present disclosure.

As illustrated in FIG. 4, the database management device 120 may receive a query operation request from the client 110 (401). Then, the database management device 120 may process the received query operation request by using three respective algorithms in order to extract performance variable values for three respective algorithms (algorithms A, B, and C) by the cost based optimizer (403, 404, and 405).

As described above in association with FIG. 3, the database management device 120 may perform a first performance test by processing the received query operation request by using three respective algorithms only with respect to some data associated with the corresponding query.

Then, the database management device 120 may decide one algorithm among three algorithms through the first performance test. The database management device 120 may process residual parts of the corresponding query by using one decided algorithm (406, 407, and 408).

Referring to step 409, the database management device 120 (for example, the query processing module 205) may decide whether the operation for the corresponding query is completed (409). When it is determined that the operation for the corresponding query is completed, the process proceeds to step 411, and as a result, the database management device 120 (for example, the query processing module 205) may decide to output a processing result of the query operation (411).

When it is determined that the operation for the corresponding query is not completed, the database management device 120 (for example, the performance test executing module 203) may perform an additional performance calculation (that is, a second performance test) for the three respective algorithms in a current state (that is, a state in which the corresponding query is processed) (410).

The database management device 120 may dynamically decide a point of time when the algorithm which is currently executed to process the query is changed to another algorithm according to a result of the second performance test. Then, when the corresponding change point of time has arrived, the database management device 120 may change the currently executed algorithm to a different algorithm according to the calculated algorithm prediction performance value.

The flowchart illustrated in FIG. 4 is just an example for describing the present disclosure and an additional step may be present and/or some steps may be omitted.

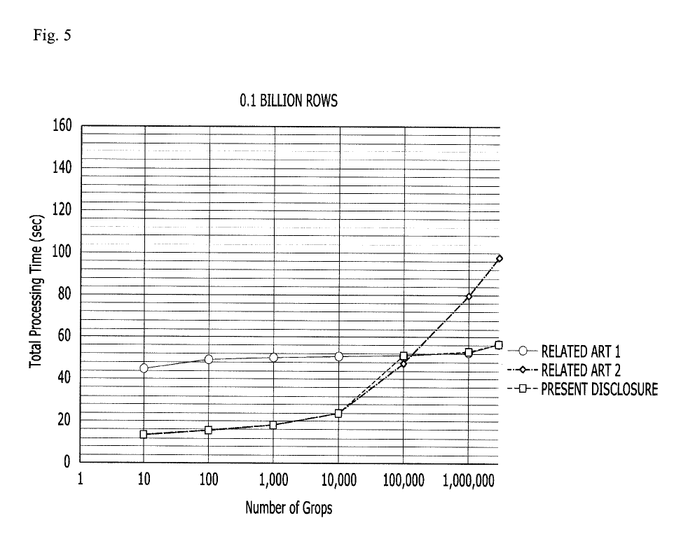

FIG. 5 is a diagram illustrating a comparison of the query processing time of the present disclosure and a query processing time in other related art.

In FIG. 5, a horizontal axis means the number of groups associated with the corresponding query and a vertical axis means a total time required to process the corresponding query. Further, it is assumed that a graph illustrated in FIG. 5 shows a situation in which a total of 0.1 billion rows are present. Related art 1 in FIG. 5 may correspond to the first execution algorithm and the first execution algorithm is illustrated as an execution algorithm having a query processing speed irrelevant to the number of groups. Related art 2 in FIG. 5 may correspond to the second execution algorithm and in the second execution algorithm, when the number of groups is 100,000 or more, it can be seen that the query processing speed is rapidly reduced.

According to a technique according an exemplary embodiment of the present disclosure, when the number of groups processed through the first performance test is small, the corresponding query may be processed according to the second performance algorithm and when the number of groups is a specific number or more, the second performance algorithm is changed to the first performance algorithm having a higher processing speed than the second performance algorithm to process the corresponding query. Therefore, as illustrated in FIG. 5, according to the technique according to the exemplary embodiment of the present disclosure, since the execution algorithm may be dynamically changed by considering the performance variables of the respective execution algorithms and the currently processed query state, a time required to process the query may be minimized as compared with the related art.

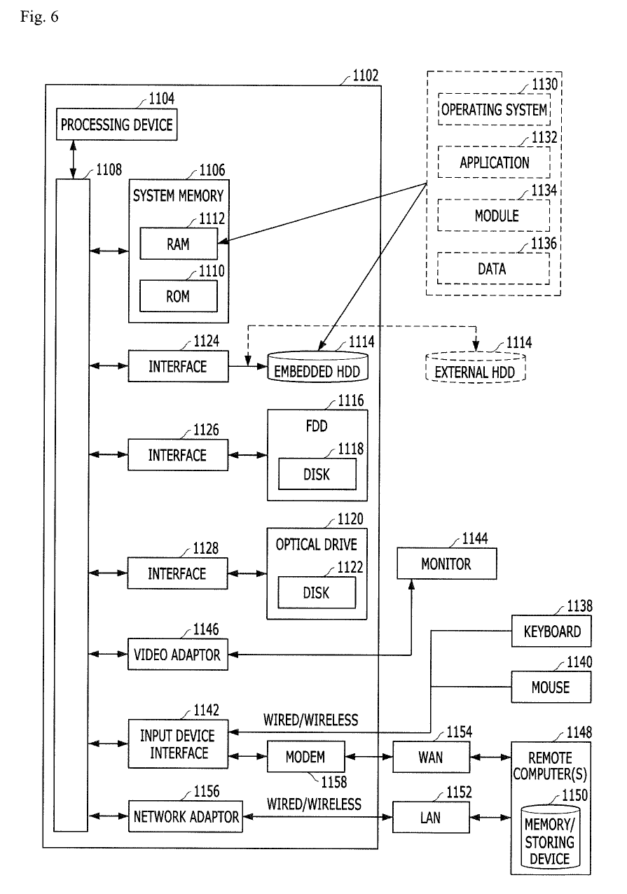

FIG. 6 illustrates a simple and general schematic view of an exemplary computing environment in which exemplary embodiments of the present disclosure can be implemented.

The present disclosure has generally been described above in association with a computer executable command which may be executed on one or more computers, but it will be well appreciated by those skilled in the art that the present disclosure can be implemented through a combination with other program modules and/or a combination of hardware and software.

In general, the program module includes a routine, a procedure, a program, a component, a data structure, and the like that execute a specific task or implement a specific abstract data type. Further, it will be well appreciated by those skilled in the art that the method of the present disclosure can be implemented by other computer system configurations including a personal computer, a handheld computing device, microprocessor-based or programmable home appliances, and others (the respective devices may operate in connection with one or more associated devices as well as a single-processor or multi-processor computer system, a mini computer, and a main computer).

The exemplary embodiments described in the present disclosure may also be implemented in a distributed computing environment in which predetermined tasks are performed by remote processing devices connected through a communication network. In the distributed computing environment, the program module may be positioned in both local and remote memory storage devices.

The computer generally includes various computer readable media. Media accessible by the computer may be computer readable media regardless of types thereof and the computer readable media include volatile and non-volatile media, transitory and non-transitory media, and mobile and non-mobile media. As not a limitation but an example, the computer readable media may include computer storage media and communication media. The computer storage media includes the volatile and non-volatile media, the transitory and non-transitory media, and the mobile and non-mobile media implemented by a predetermined method or technology for storing information such as a computer readable command, a data structure, a program module, or other data. The computer storage media include a RAM, a ROM, an EEPROM, a flash memory or other memory technologies, a CD-ROM, a digital video disk (DVD) or other optical disk storage devices, a magnetic cassette, a magnetic tape, a magnetic disk storage device or other magnetic storage devices or predetermined other media which may be accessed by the computer or may be used to store desired information, but are not limited thereto.

The communication media generally implement the computer readable command, the data structure, the program module, or other data in a carrier wave or a modulated data signal such as a transport mechanism and include all information transfer media. The term modulated data signal means a signal acquired by configuring or changing at least one of characteristics of the signal so as to encode information in the signal. As not a limitation but an example, the communication media include wired media such as a wired network or a direct-wired connection and wireless media such as acoustic, RF, infrared and other wireless media. A combination of any media among the aforementioned media is also included in the range of the computer readable media.

An exemplary environment 1100 that implements various aspects of the present disclosure including a computer 1102 is shown and the computer 1102 includes a processing device 1104, a system memory 1106, and a system bus 1108. The system bus 1108 connects system components including the system memory 1106 (not limited thereto) to the processing device 1104. The processing device 1104 may be a predetermined processor among various commercial processors. A dual processor or other multi-processor architectures may also be used as the processing device 1104.

The system bus 1108 may be any one of several types of bus structures which may be additionally interconnected to a local bus using any one of a memory bus, a peripheral device bus, and various commercial bus architectures. The system memory 1106 includes a read only memory (ROM) 1110 and a random access memory (RAM) 1112. A basic input/output system (BIOS) is stored in the non-volatile memories 1110 including the ROM, the EPROM, the EEPROM, and the like and the BIOS includes a basic routine that assists in transmitting information among components in the computer 1102 at a time such as starting. The RAM 1112 may also include a high-speed RAM including a static RAM for caching data, and the like.

The computer 1102 also includes an embedded hard disk drive (HDD) 1114 (for example, EIDE and SATA)—the embedded hard disk drive (HDD) 1114 may also be configured for an exterior purpose in an appropriate chassis (not illustrated)—, a magnetic floppy disk drive (FDD) 1116 (for example, for reading from or writing in a mobile diskette 1118), and an optical disk drive 1120 (for example, for reading a CD-ROM disk 1122 or reading from or writing in other high-capacity optical media such as the DVD, and the like). The hard disk drive 1114, the magnetic disk drive 1116, and the optical disk drive 1120 may be connected to the bus system 1108 by a hard disk drive interface 1124, a magnetic disk drive interface 1126, and an optical drive interface 1128, respectively. An interface 1124 for implementing an exterior drive includes at least one of a universal serial bus (USB) and an IEEE 1394 interface technology or both of them.

The drives and the computer readable media associated therewith provide non-volatile storage of the data, the data structure, the computer executable command, and others. In the case of the computer 1102, the drives and the media correspond to storing predeteiinined data in an appropriate digital format. In the description of the computer readable media, the mobile optical media such as the HDD, the mobile magnetic disk, and the CD or the DVD are mentioned, but it will be well appreciated by those skilled in the art that other types of media readable by the computer such as a zip drive, a magnetic cassette, a flash memory card, a cartridge, and others may also be used in an exemplary operating environment and further, the predetermined media may include computer executable commands for executing the methods of the present disclosure.

Multiple program modules including an operating system 1130, one or more application programs 1132, other program module 1134, and program data 1136 may be stored in the drive and the RAM 1112. All or some of the operating system, the application, the module, and/or the data may also be cached by the RAM 1112. It will be well appreciated that the present disclosure may be implemented in various operating systems which are commercially usable or a combination of the operating systems.

A user may input commands and information in the computer 1102 through one or more wired/wireless input devices, for example, pointing devices such as a keyboard 1138 and a mouse 1140. Other input devices (not illustrated) may include a microphone, an IR remote controller, a joystick, a game pad, a stylus pen, a touch screen, and others. The devices and other input devices are often connected to the processing device 1104 through an input device interface 1142 connected to the system bus 1108, but may be connected by other interfaces including a parallel port, an IEEE 1394 serial port, a game port, a USB port, an IR interface, and others.

A monitor 1144 or other types of display devices are also connected to the system bus 1108 through interfaces such as a video adapter 1146, and the like. In addition to the monitor 1144, the computer generally includes a speaker, a printer, and other peripheral output devices (not illustrated).

The computer 1102 may operate in a networked environment by using a logical connection to one or more remote computers including remote computer(s) 1148 through wired and/or wireless communication. The remote computer(s) 1148 may be a workstation, a server computer, a router, a personal computer, a portable computer, a micro-processor based entertainment apparatus, a peer device, or other general network nodes and generally includes multiple components or all of the components described with respect to the computer 1102, but only the memory storage device 1150 is illustrated for brief description. The illustrated logical connection includes a wired/wireless connection to a local area network (LAN) 1152 and/or a larger network, for example, a wide area network (WAN) 1154. The LAN and WAN networking environments are general environments in offices and companies and facilitate an enterprise-wide computer network such as Intranet, and the like and all of them may be connected to a worldwide computer network, for example, the Internet.

When the computer 1102 is used in the LAN networking environment, the computer 1102 is connected to a local network 1152 through a wired and/or wireless communication network interface or an adapter 1156. The adapter 1156 may facilitate the wired or wireless communication in the LAN 1152 and the LAN 1152 also includes a wireless access point installed therein in order to communicate with the wireless adapter 1156. When the computer 1102 is used in the WAN networking environment, the computer 1102 may include a modem 1158 or have other means that configure communication through the WAN 1154 such as connection to a communication server on the WAN 1154 or connection through the Internet. The modem 1158 which may be an embedded or exterior and wired or wireless device is connected to the system bus 1108 through the serial port interface 1142. In the networked environment, the program modules described with respect to the computer 1102 or some thereof may be stored in the remote memory/storage device 1150. The illustrated network connection is exemplary and it will be well appreciated that other means configuring a communication link among computers may be used.

The computer 1102 performs an operation of communicating with predetermined wireless devices or entities which are disposed and operated by the wireless communication, for example, the printer, a scanner, a desktop and/or portable computer, a portable data assistant (PDA), a communication satellite, predetermined equipment or place associated with a wireless detectable tag, and a telephone. This at least includes Wi-Fi and a Bluetooth wireless technology. Accordingly, communication may be a predefined structure like the network in the related art or just ad hoc communication between at least two devices.

Wireless fidelity (Wi-Fi) enables connection to the Internet, and the like without a wired cable. Wi-Fi is a wireless technology such as the device, for example, a cellular phone which enables the computer to transmit and receive data indoors or outdoors, that is, anywhere in a communication range of a base station. The Wi-Fi network uses a wireless technology called IEEE 802.11(a, b, g, and others) in order to provide safe, reliable, and high-speed wireless connection. Wi-Fi may be used to connect the computers to each other or the Internet and the wired network (using IEEE 802.3 or Ethernet). The Wi-Fi network may operate, for example, at a data rate of 11 Mbps(802.11a) or 54 Mbps(802.11b) in unlicensed 2.4 and 5 GHz wireless bands or operate in a product including both bands (dual bands).

It may be appreciated by those skilled in the art that various exemplary logical blocks, modules, processors, means, circuits, and algorithm steps described in association with the exemplary embodiments disclosed herein may be implemented by electronic hardware, various types of programs or design codes (for easy description, herein, designated as “software”), or a combination of all of them. In order to clearly describe the intercompatibility of the hardware and the software, various exemplary components, blocks, modules, circuits, and steps have been generally described above in association with functions thereof Whether the functions are implemented as the hardware or software depends on design restrictions given to a specific application and an entire system. Those skilled in the art of the present disclosure may implement functions described by various methods with respect to each specific application, but it should not be analyzed that the implementation determination departs from the scope of the present disclosure.

Various embodiments presented herein may be implemented as manufactured articles using a method, an apparatus, or a standard programming and/or engineering technique. The term “manufactured article” includes a computer program, a carrier, or a medium which is accessible by a predetermined computer-readable device. For example, a computer-readable medium includes a magnetic storage device (for example, a hard disk, a floppy disk, a magnetic strip, or the like), an optical disk (for example, a CD, a DVD, or the like), a smart card, and a flash memory device (for example, an EEPROM, a card, a stick, a key drive, or the like), but is not limited thereto. Further, various storage media presented herein include one or more devices and/or other machine-readable media for storing information. The term “machine-readable media” includes a wireless channel and various other media that can store, possess, and/or transfer command(s) and/or data, but is not limited thereto.

It will be appreciated that a specific order or a hierarchical structure of steps in the presented processes is one example of exemplary accesses. It will be appreciated that the specific order or the hierarchical structure of the steps in the processes within the scope of the present disclosure may be rearranged based on design priorities. Appended method claims provide elements of various steps in a sample order, but it does not mean that the method claims are limited to the presented specific order or hierarchical structure.

The description of the presented embodiments is provided so that those skilled in the art of the present disclosure use or implement the present disclosure. Various modifications of the embodiments will be apparent to those skilled in the art and general principles defined herein can be applied to other embodiments without departing from the scope of the present disclosure. Therefore, the present disclosure is not limited to the embodiments presented herein, but should be analyzed within the widest range which is consistent with the principles and new features presented herein.

What is claimed is:

1. A method for reducing a query processing time by dynamically changing algorithms in a database management system (DBMS), the method comprising:
receiving a database query from a client;
executing a first performance test for each of a plurality of execution algorithms for performing an operation associated with the database query;
executing an operation for processing the database query by using a first execution algorithm among the plurality of execution algorithms based on a result of the first performance test; and
during the executing of the operation for processing the database query by using the first execution algorithm:
executing a second performance test for each of the plurality of execution algorithms for the performing of the operation associated with the database query; and
dynamically determining a point of time when the first execution algorithm is changed to a second execution algorithm among the plurality of execution algorithms in the operation for processing the database query based on a result of the second performance test.

2. The method of claim 1, wherein the executing of the first performance test includes:
determining the plurality of execution algorithms for the performing of the operation associated with the database query,
extracting a first value of one or more respective performance variables for the respective determined execution algorithms, and
determining a first predicted performance value for the respective determined execution algorithms based on the extracted first value for the one or more respective performance variables.

3. The method of claim 2, wherein the extracting of the first value of the one or more performance variables includes extracting the first value of the one or more respective performance variables by initially processing a portion of data associated with the database query by using the respective determined execution algorithms.

4. The method of claim 3, wherein the executing of the second performance test includes determining a second predicted performance value for the respective determined execution algorithms based on a second value for the one or more respective performance variables, dynamically acquired during the performing of the operation for processing the database query.

5. The method of claim 4, wherein the first and second predicted performance values include time values generated in the operation for processing the database query when corresponding execution algorithms are used.

6. The method of claim 4, wherein the one or more respective performance variables includes at least one of a row count, a group count, and a current state of a resource.

7. The method of claim 1, wherein the database query includes a query associated with a Group By operator, and
the plurality of execution algorithms includes a Quick-Sort Based Group By algorithm and an R-B tree Based Group By algorithm.

8. The method of claim 1, wherein the receiving of the database query, the executing of the first performance test, the executing of the operation for processing the database query, the executing of the second performance test, and the determining of the point of time are performed in a memory of the DBMS.

9. A non-transitory computer-readable medium storing a computer program including encoded commands, the computer program allowing one or more processors of a computer system to perform the following operations for reducing a query processing time by dynamically changing algorithms in a database management system (DBMS) when the computer program is executed by the one or more processors, the operations comprising:
receiving a database query from a client;
executing a first performance test for each of a plurality of execution algorithms for performing an operation associated with the database query;
executing an operation for processing the database query by using a first execution algorithm among the plurality of execution algorithms based on a result of the first performance test; and
during the executing of the operation for processing the database query by using the first execution algorithm:
executing a second performance test for each of the plurality of execution algorithms for the performing of the operation associated with the database query; and
dynamically determining a point of time when the first execution algorithm is changed to a second execution algorithm among the plurality of execution algorithms in the operation for processing the database query based on a result of the second performance test.

10. The non-transitory computer-readable medium of claim 9, wherein the executing of the first performance test includes:
determining the plurality of execution algorithms for the performing of the operation associated with the database query,
extracting a first value of one or more respective performance variables for the respective determined execution algorithms, and
determining a first predicted performance value for the respective determined execution algorithms based on the extracted first value for the one or more respective performance variables.

11. The non-transitory computer-readable medium of claim 10, wherein the extracting of the first value of the one or more performance variables includes extracting the first value of the one or more respective performance variables by initially processing a portion of data associated with the database query by using the respective determined execution algorithms.

12. The non-transitory computer-readable medium of claim 11, wherein the executing of the second performance test includes determining a second predicted performance value for the respective determined execution algorithms based on a second value for the one or more respective performance variables, dynamically acquired during the performing of the operation for processing the database query.

13. The non-transitory computer-readable medium of claim 12, wherein the first and second predicted performance values include time values generated in the operation for processing the database query when the corresponding execution algorithms are used.

14. The non-transitory computer-readable medium of claim 12, wherein the one or more respective performance variables includes at least one of a row count, a group count and a current state of a resource.

15. The non-transitory computer-readable medium of claim 9, wherein the database query includes a query associated with a Group By operator, and
the plurality of execution algorithms includes a Quick-Sort Based Group By algorithm and an R-B tree Based Group By algorithm.

16. A database management device for reducing a query processing time by dynamically changing algorithms, the database management device comprising:
a query receiver configured to receive a database query from a client;
a performance test executor configured to execute a first performance test for each of a plurality of execution algorithms for performing an operation associated with the database query; and
a query processor for executing an operation for processing the database query by using a first execution algorithm among the plurality of execution algorithms based on a result of the first performance test; and
wherein during execution of the operation for processing the database query by using the first execution algorithm, the performance test executor is further configured to execute a second performance test for each of the plurality of execution algorithms for the performing of the operation associated with the database query, and
wherein the database management device further includes an algorithm changer for dynamically deciding a point of time when the first execution algorithm is changed to a second execution algorithm among the plurality of execution algorithms in the operation for processing the database query based on a result of the second performance test.
